(19) United States
(12) Patent Application Publication
(10) Pub. No.: US 2007/0294087 A1
(43) Pub. Date: Dec. 20, 2007

(54) Synthesizing comfort noise

(75) Inventor: Ari Lakaniemi, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/418,811

(22) Filed: May 5, 2006

(51) Int. Cl. G10L 13/00

(52) U.S. Cl. 704/262

(57) ABSTRACT

In order to improve the audio quality of an audio signal including comfort noise, a time scaling is performed as an integral part of a comfort noise signal synthesis.

### FIELD OF THE INVENTION

The invention relates to a method for synthesizing comfort noise. The invention relates equally to an apparatus, to an audio receiver, to an electronic device and to a system synthesizing comfort noise. The invention relates further to a software program product storing a software code for synthesizing comfort noise.

### BACKGROUND OF THE INVENTION

For a transmission of voice, speech frames may be encoded at a transmitter, transmitted via a network, and decoded again at a receiver for presentation to a user.

During periods when the transmitter has no active speech to transmit, the normal transmission of speech frames may be switched off. The encoder may generate during these periods instead a set of comfort noise parameters describing the background noise that is present at the transmitter. These comfort noise parameters may be sent to the receiver, usually at a reduced bit-rate and/or at a reduced transmission interval compared to the speech frames. The receiver uses the comfort noise parameters to synthesize an artificial, noise-like signal having characteristics close to those of the background noise signal present at the transmitter.

In the Adaptive Multi-Rate (AMR) speech codec, for example, the comfort noise parameters used for comfort noise generation are linear prediction (LP) synthesis filter coefficients describing the spectral contents of the background noise signal and a gain factor representing the energy of the background noise signal. These parameters are transmitted from the transmitter to the receiver in silence descriptor (SID) frames at 160 ms intervals, instead of the 20 ms intervals used for active speech. At the receiver, a comfort noise signal is then generated by first constructing an excitation signal for an LP synthesis filter. The excitation signal is constructed by creating four subframes, each subframe including ten non-zero pulses at random positions. The signal level is brought to the desired level by multiplying the pulse amplitudes by the received gain factor. The final comfort noise signal is created by applying an LP synthesis filter with the received LP synthesis filter coefficients to the locally generated excitation signal. It has to be noted that while the SID frames are only transmitted in intervals of 160 ms, new comfort noise frames are synthesized nevertheless at 20 ms intervals. The comfort noise parameters for the comfort noise frames between the SID updates are interpolated using the comfort noise parameters in the most recent received SID frames. That is, following upon each comfort noise frame that is synthesized based on a set of comfort noise parameters received in a SID frame, there are seven comfort noise frames that are synthesized based on interpolated comfort noise parameters.

Audio signals including speech frames and comfort noise parameters may be transmitted from a transmitter to a receiver for instance via a packet switched network, such as the Internet.

The nature of packet switched communications typically introduces variations to the transmission times of the packets, known as jitter, which is seen by the receiver as packets arriving at irregular intervals. In addition to packet loss conditions, network jitter is a major hurdle especially for conversational speech services that are provided by means of packet switched networks.

More specifically, an audio playback component of an audio receiver operating in real-time requires a constant input to maintain a good sound quality. Even short interruptions should be prevented. Thus, if some packets comprising audio frames arrive only after the audio frames are needed for decoding and further processing, those packets and the included audio frames are considered as lost. The audio decoder will perform error concealment to compensate for the audio signal carried in the lost frames. Obviously, extensive error concealment will reduce the sound quality as well, though.

Typically, a jitter buffer is therefore utilized to hide the irregular packet arrival times and to provide a continuous input to the decoder and a subsequent audio playback component. The jitter buffer stores to this end incoming audio frames for a predetermined amount of time. This time may be specified for instance upon reception of the first packet of a packet stream. A jitter buffer introduces, however, an additional delay component, since the received packets are stored before further processing. This increases the end-to-end delay. A jitter buffer can be characterized by the average buffering delay and the resulting proportion of delayed frames among all received frames.

A jitter buffer using a fixed delay is inevitably a compromise between a low end-to-end delay and a low number of delayed frames, and finding an optimal tradeoff is not an easy task. Although there can be special environments and applications where the amount of expected jitter can be estimated to remain within predetermined limits, in general the jitter can vary from zero to hundreds of milliseconds—even within the same session. Using a fixed delay that is set to a sufficiently large value to cover the jitter according to an expected worst case scenario would keep the number of delayed frames in control, but at the same time there is a risk of introducing an end-to-end delay that is too long to enable a natural conversation. Therefore, applying a fixed buffering is not the optimal choice in most audio transmission applications operating over a packet switched network.

An adaptive jitter buffer can be used for dynamically controlling the balance between a sufficiently short delay and a sufficiently low number of delayed frames. In this approach, the incoming packet stream is monitored constantly, and the buffering delay is adjusted according to observed changes in the delay behavior of the incoming packet stream. In case the transmission delay seems to increase or the jitter is getting worse, the buffering delay is increased to meet the network conditions. In an opposite situation, the buffering delay can be reduced, and hence, the overall end-to-end delay is minimized.

Since the audio playback component needs a regular input, the buffer adjustment is not completely straightforward, though. A problem arises from the fact that if the buffering delay is reduced, the audio signal that is provided to the playback component needs to be shortened to compensate for the shortened buffering delay, and on the other hand, if the buffering delay is increased, the audio signal has to be lengthened to compensate for the increased buffering delay.

A time scale modification of an active speech signal can be used for enabling a fast and flexible buffering delay adjustment, but such a time scale modification may introduce voice quality and intelligibility problems. In another approach, the buffering delay adjustment could be restricted to occur only during comfort noise periods—for example in the beginning of a comfort noise period. While this somewhat limits the flexibility of the adjustment operation, the time scaling of a comfort noise signal can be expected not to degrade the subjective voice quality.

For Voice over IP (VoIP) applications, for example, it is known to adapt the comfort noise signal to an increasing or decreasing buffer delay by discarding or repeating a part of the generated comfort noise signal between the periods of active speech. However, a straightforward removal or repetition of parts of a comfort noise signal is not an optimal choice in terms of audio quality either. Removal or repetition of a signal part introduces a point of discontinuity in the resulting time scaled comfort noise signal that may be noticed by a user as quality degradation.

In case short segments of the comfort noise signal are removed or repeated, it is possible that sudden local energy variations are introduced unintentionally. This may happen for example when a segment of comfort noise containing a relatively high number of randomly placed non-zero pulses is removed, or when a segment of comfort noise containing a relatively low number of randomly placed non-zero pulses is repeated. Furthermore, repeating a segment of the comfort noise signal may introduce an undesired periodic pattern, which may introduce annoying audible effect to the time scaled output signal.

In case long segments of the comfort noise signal are removed or repeated, the point of discontinuity may result in a significant sudden change of the signal level, for example in case there is a decreasing or increasing trend in the signal level. This may result in a clearly audible ‘click’ in the played back modified comfort noise signal.

### SUMMARY OF THE INVENTION

It is an object of the invention to improve the audio quality of an audio signal including comfort noise.

A method is proposed, which comprises synthesizing a comfort noise signal. The method further comprises performing a time scaling as an integral part of this comfort noise signal synthesis.

Moreover, an apparatus is proposed, which comprises a comfort noise generator configured to synthesize a comfort noise signal and to perform a time scaling as an integral part of the comfort noise signal synthesis.

The comfort noise generator can be realized in hardware and/or in software. The apparatus could be for instance a processor executing a corresponding software program code. Alternatively, the apparatus could be or comprise for instance a chipset with at least one chip, i.e., an integrated circuit, where the comfort noise generator is realized by a circuit implemented on this chip.

Moreover, an audio receiver is proposed, which comprises the proposed apparatus and in addition a time scaling control logic configured to determine a required amount of time scaling, which is to be applied by the apparatus.

Moreover, an electronic device is proposed, which comprises the proposed apparatus and in addition a playback component configured to playback a comfort noise signal synthesized by the apparatus.

Moreover, a system is proposed, which comprises a packet switched network, a transmitter configured to provide comfort noise parameters for transmission via the packet switched network and a receiver configured to receive comfort noise parameters via the packet switched network. The receiver includes a comfort noise generator that is configured to synthesize a comfort noise signal based on comfort noise parameters received by the receiver and to perform a time scaling as an integral part of the comfort noise signal synthesis.

Finally, a software program product is proposed, in which a software program code is stored in a readable medium. When being executed by a processor, the software program code realizes the proposed method. The software program product can be for example a separate memory device or a memory that is to be implemented in an audio receiver, etc.

The invention proceeds from the consideration that the unfavorable repetition or removal of a segment of a generated comfort noise signal can be avoided, if the comfort noise signal is generated with the currently required signal length. It is therefore proposed that the synthesis of the comfort noise signal takes account of the required time scaling.

It is an advantage of the invention that it allows synthesizing the comfort noise signal from the outset with the desired length. Thereby, points of discontinuity resulting with a removal or a repetition of a segment of the comfort noise signal can be avoided. Thus, the sound quality of the comfort noise is improved. The proposed approach can further be realized with very low-complexity.

The invention can be employed for example for a time scaling compensating for a changing buffering delay. In one embodiment of the invention, audio data, which is received via a packet switched network, is buffered in an adaptive jitter buffer. Such audio data may comprise for instance speech frames and frames including comfort noise parameters that can be used as a basis for the synthesis of the comfort noise signal. Moreover, a ratio is determined between a required length of a comfort noise signal, which required length depends on reception statistics on the audio data, to a default length of a comfort noise signal. Such reception statistics are suited to indicate any change of the buffering delay in the adaptive jitter buffer. The time scaling may then be performed in accordance with this determined ratio. The decision on whether and to which extent to apply a time scaling during a comfort noise period can be made for example inter alia based on the reception statistics during an active speech period preceding the comfort noise period.

In one embodiment of the invention, the time scaling comprises adjusting the energy per time unit of the comfort noise signal, that is, the signal power, to approach the energy per time unit that would result without time scaling. The transition to and from a modified comfort noise signal can be smooth and does not introduce any audible artifacts. This ensures that the time-scaling is hidden entirely from the user.

In one embodiment of the invention, synthesizing a comfort noise signal comprises generating an excitation signal and applying a linear prediction synthesis filtering to the excitation signal. In this case, the integrated time scaling may be realized for instance by time scaling the excitation signal.

A time scaled excitation signal may be generated for example by creating an excitation signal, which has a length that corresponds to a desired length of the comfort noise signal and which includes a number of non-zero pulses that is adjusted to the desired length. That is, a shorter excitation signal will have less non-zero pulses than a longer excitation signal. A suitably selected number of pulses guarantees that the signal level and thus the energy per time unit remains at the desired level without any additional computations.

An excitation signal may be composed of a predetermined or a variable number of subframes, even though this is not indispensable. The length of the subframes can be determined by adjusting a default length of a subframe in accordance with a ratio between a desired length of the comfort noise signal and a default length of a comfort noise signal. Each of the subframes may include a selected number of non-zero pulses at random positions. The selected number of non-zero pulses can be determined by adjusting a default number of pulses per subframe according to the indicated ratio.

The length of the subframes is advantageously selected to lie between a predetermined maximum value and a predetermined minimum value. This can be achieved for instance by adjusting a determined ratio to lie within a predetermined range before it is used for determining the length of the subframes. Alternatively, the length of the subframes could be determined based on an unconfined ratio, and the determined length could then be adjusted, if required, to lie within a predetermined range. Also the number of non-zero pulses is advantageously selected to lie between a predetermined maximum value and a predetermined minimum value.

Providing a minimum length for the subframes may be beneficial, because with a very short subframe length, the changed number of non-zero pulses might give a poor estimate of the desired signal power. The reason for this effect is that while the subframes may be continuously scaled to any length, the adjusted number of non-zero pulses per subframe has always to be an integer value. This problem might also be alleviated by using different subframe lengths in one frame if needed.

In a practical implementation, it might moreover be a problem to use subframes that are too short. Such frames could result in running a respective comfort noise generation too frequently, for example, in only a few millisecond intervals. Such might not be feasible on all platforms.

Providing a maximum length for the subframes has the advantage that it is suited to limit the amount of memory that is needed for handling the extended subframes and frames.

In a particularly simple approach, the subframes of a respective excitation signal have the same length and the same number of non-zero pulses. It is to be understood, though, that the length and the number of non-zero pulses could also be selected individually for each subframe. This might enable a particularly fast adaptation to a required change even within a single frame of comfort noise signal. Further, as mentioned above, it might allow minimizing the discrepancy between a desired signal power and an achieved signal power in each subframe.

The invention can be applied to any type of audio codec, in particular, though not exclusively, to any type of speech codec, like the AMR codec or the Adaptive Multi-Rate Wideband (AMR-WB) codec. Further, it can be used for instance for VoIP.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a transmission system according to an embodiment of the invention; and

FIG. 2 is a flow chart illustrating an operation in the audio receiver of FIG. 1.

### DETAILED DESCRIPTION OF THE INVENTION

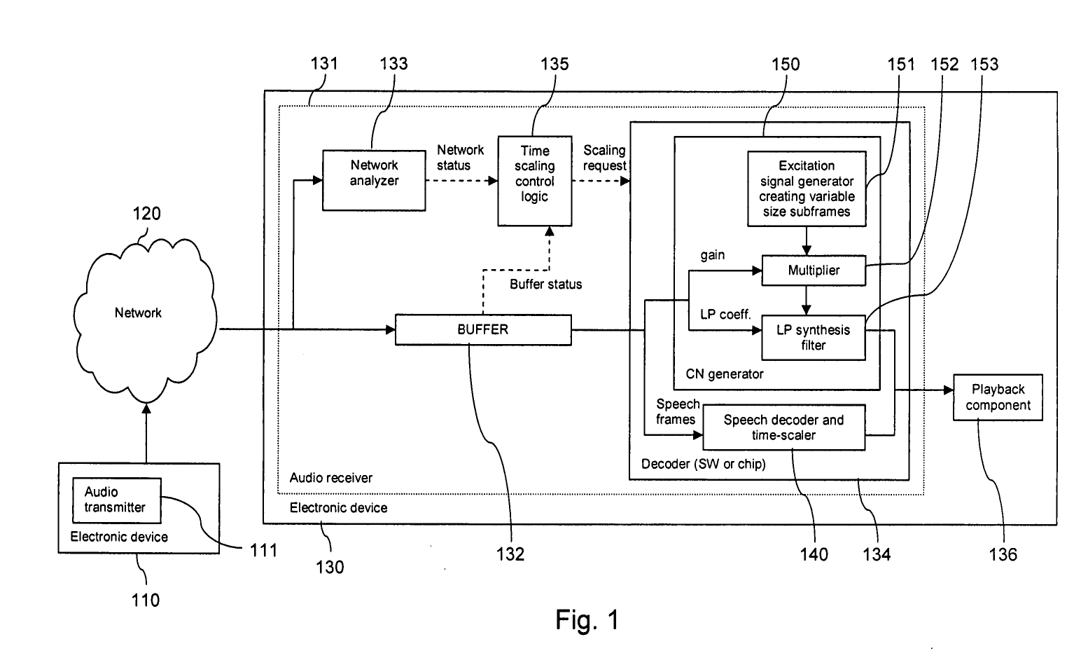

FIG. 1 is a schematic block diagram of an exemplary AMR-based transmission system, in which an enhanced comfort noise generation according to an embodiment of the invention may be implemented.

The system comprises an electronic device 110 with an audio transmitter 111, a packet switched communication network 120 and an electronic device 130 with an audio receiver 131.

The input of the audio receiver 131 is connected within the audio receiver 131 on the one hand to a jitter buffer 132 and on the other hand to a network analyzer 133. The jitter buffer 132 is connected via a decoder 134 to the output of the audio receiver 131. A control signal output of the network analyzer 133 is connected to a first control input of a time scaling control logic 135, while a control signal output of the jitter buffer 132 is connected to a second control input of the time scaling control logic 135. A control signal output of the time scaling control logic 135 is further connected to a control input of the decoder 134.

The decoder 134 includes a speech frame decoder 140 and a comfort noised generator 150. The speech frame decoder 140 may include or be followed by a time scaling component (not shown). The comfort noise generator 150 comprises an excitation signal generator 151, which is linked via a multiplier component 152 of the comfort noised generator 150 to an LP synthesis filter component 153 of the comfort noised generator 150.

The comfort noise generator 150 or the entire decoder 134 may be implemented by a software code that can be executed by a processor (not shown) of the electronic device 131. It is to be understood that the same processor could execute in addition software codes realizing other functions of the audio receiver 131 or, in general, of the electronic device 130. It has to be noted that, alternatively, the functions of the comfort noise generator could be realized by hardware, for instance by a circuit integrated in a chip or a chipset.

The output of the audio receiver 131 may be connected to a playback component 136 of the electronic device 130, for example to loudspeakers.

It is to be understood that the presented architecture of the audio receiver 131 of FIG. 1 is only intended to illustrate the basic logical functionality of an exemplary audio receiver according to the invention. In a practical implementation, the represented functions can be allocated differently to processing blocks. Furthermore, there may be additional processing blocks, and some components, like the buffer 132, may even be arranged outside of the audio receiver 131. With that in mind, the functions illustrated by the comfort noise generator 150 can be viewed as means for synthesizing a comfort noise signal while the excitation signal generator 151 can be viewed as means for performing a time scaling in accordance with a determined ratio between a required length of the comfort noise signal and a default length as an integral part of the comfort noise synthesis. Other functions shown in FIG. 1 such as the control logic 135 or the network analyzer or both may in some but not all cases also be viewed as forming a part of the means for time scaling or the means for synthesizing, or both, since their functions overlap in the sense that the time scaling is performed as an integral part of the disclosed comfort noise synthesis, as described in more detail below. However, the time scaling control logic 135, either alone or together with the network analyzer 133, may instead be viewed as separate means for determining the above-mentioned ratio between a required length of the comfort noise signal and a default length as described in more detail below. The buffer 132 may be viewed as means for buffering the audio data within the audio receiver.

Apart from the generation of a comfort noise signal, the presented system may be implemented just like a conventional system in which audio data is transmitted from an audio transmitter to an audio receiver.

When speech is to be transmitted from electronic device 110 to electronic device 130, for instance in the scope of a VoIP session, the audio transmitter 111 assembles audio frames and transmits them via the packet switched communication network 120 to the audio receiver 131, as known from the art. The audio frames may be partly active speech frames and partly SID frames. Active speech frames are transmitted at 20 ms intervals, while SID frames are transmitted at 160 ms intervals. The SID frames comprise 35 bits of comfort noise parameters describing the background noise present at the transmitting end. The comfort noise parameters may include LP synthesis filter coefficients and gain factors that are generated in a conventional manner by the audio transmitter 111.

The jitter buffer 132 stores received audio frames waiting for decoding and playback. The jitter buffer 132 may have the capability to arrange received frames into the correct decoding order and to provide the arranged frames—or information about missing frames—in sequence to the decoder 134 upon request. In addition, the jitter buffer 132 provides information about its status to the time scaling control logic 135. The network analyzer 133 computes a set of parameters describing the current reception characteristics based on frame reception statistics and the timing of received frames and provides the set of parameters to the time scaling control logic 135 shown as a network status signal in FIG. 1. Based on the received information, the time scaling control logic 135 determines the need for a changing buffering delay and gives corresponding time scaling commands shown as a scaling request signal in FIG. 1 to the decoder 134. The used average buffering delay does not have to be an integer multiple of the input frame length. The optimal average buffering delay is the one that minimizes the buffering time without any frames arriving late.

The decoder 134 retrieves an audio frame from the buffer 132 whenever new data is requested by the playback component 136, unless the new data is currently to be generated based on previously retrieved SID frames. In case a retrieved audio frame is a speech frame, it is provided to the speech frame decoder 140. In case a retrieved audio frame is an SID frame, it is provided to the comfort noise generator 150.

The speech frame decoder 140 decodes received speech frames, applies a time scaling in accordance with a current time scaling request from the time scaling control logic 135, and provides the decoded and time scaled speech frames to the playback component 136 for presentation to a user. The decoding and time scaling of the speech frames may be realized in any suitable manner.

The comfort noise generator 150 extracts comfort noise parameters from received SID frames. In between the reception of two SID frames, the comfort noise generator 150 moreover interpolates sets of comfort noise parameters based on the comfort noise parameters extracted from preceding SID frames. Further, it generates comfort noise signals based the extracted or interpolated comfort noise parameters such that the generated comfort noise signals are already time scaled in accordance with a current time scaling request from the time scaling control logic 135. The generated comfort noise signals are equally provided to the playback component 136 for presentation to a user.

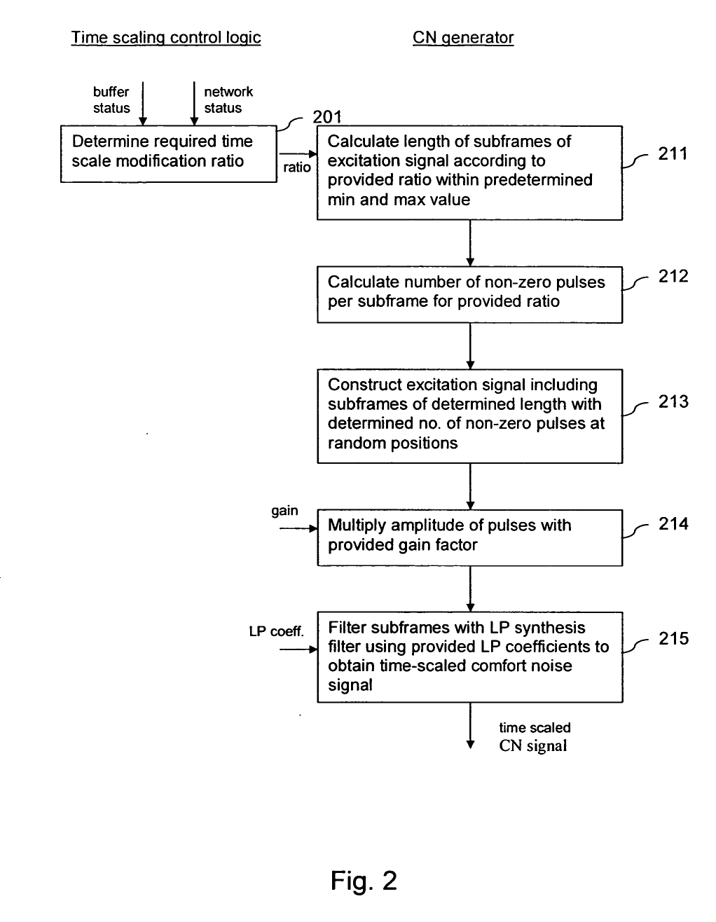

The generation of comfort noise signals will now be described in more detail with reference to the flow chart of FIG. 2. FIG. 2 presents on the left hand side a step which may for example be performed by the time scaling control logic 135 and on the right hand side the steps which may for example be performed by the comfort noise generator 150.

As mentioned above, the time scaling control logic 135 receives information on the network status from the network analyzer 133 and information on the buffer status from the jitter buffer 132. Based on this information, it determines whether a change of the buffering delay is impending and, if so, it determines in addition the amount of time scaling that is required for compensating for the change (step 201). When network characteristics and buffer status indicate an increasing delay, some frames have to be lengthened by an appropriate amount so that the playback component 136 requests new data at a lower rate in order to prevent a buffer underflow while the buffering delay is being increased. When network characteristics and buffer status indicate a decreasing delay, some frames have to be shortened by an appropriate amount so that the playback component 136 requests new data at a higher rate in order to prevent a buffer overflow while the buffering delay is being decreased. The required amount of time scaling can be determined for instance in the form of a time scale modification ratio, that is, the required length of the time scaled output signal divided by the normal or default output length.

The time scaling control logic 135 generates a time scaling request or equivalent command including the required time scale modification ratio and provides it to the decoder 134.

In case the next frame that is to be provided to the playback component 136 is a comfort noise frame, the excitation signal generator 151 receives the time scaling request or command and calculates the length of four subframes of an excitation signal based on the time scale modification ratio included in the time scaling request or command (step 211). This length Lₒᵤₜ can be calculated for example based on the following equation:
Lₒᵤₜ=r*Lₙₒᵣₘ, rₘᵢₙ≦r≦rₘₐₓ
where Lₙₒᵣₘ is the nominal or default length of the subframes. In the case of AMR, this nominal or default length is 40 samples, which corresponds to 5 ms. r is the time scale modification ratio, which is adjusted not to fall short of a lower limit rₘᵢₙ and not to exceed an upper limit rₘₐₓ, if required. In the case of AMR, rₘᵢₙ could be for instance equal to 0.25 and rₘₐₓ could be for instance equal to 2.

The excitation signal generator 151 calculates in addition the number of non-zero pulses in each subframe of the excitation signal (step 212). The number of non-zero pulses Nᵣ is calculated as well based on the time scale modification ratio, for example in accordance with the following equation:
Nᵣ=round(r*Nₙₒᵣₘ)

Here, Nₙₒᵣₘ is the nominal number of non-zero pulses in a normal comfort noise subframe having the nominal or default length Lₙₒᵣₘ. For AMR, this nominal number of non-zero pulses is ten per subframe. r is again the time scale modification ratio, which is adjusted not to fall short of the lower limit rₘᵢₙ and not to exceed the upper limit rₘₐₓ, if required. The function round( ) represents rounding to the nearest integer value.

The above mentioned effect of the selected lower limit rₘᵢₙ on the accuracy of the achieved signal power can be explained more clearly by means of an example. If the ratio is set for instance to r=0.15, the number of non-zero pulses will be Nᵣ=round(0.15*10)=2. However, the number of pulses that would give the desired signal power would be 1.5, thus the difference is (2−1.5)/1.5=33%. If the ratio is set in contrast to r=0.55, the maximum deviation from the desired number of pulses would be Nᵣ=round(0.55*10)=6, while the optimal number of pulses would be 5.5, leading to a difference of only (6−5.5)/5.5=9%. Thus, it is beneficial to provide a lower limit for the ratio r in order to guarantee a certain accuracy of the achieved signal power. Alternatively or in addition, it could be beneficial to use subframe lengths that minimize the difference between the fractional number of pulses that would give the desired signal power and a rounded number of pulses, for example by using different subframe lengths within a frame if needed.

The excitation signal generator 151 may now generate an excitation signal including four subframes of the calculated length Lₒᵤₜ, each subframe with Nᵣ randomly places non-zero pulses (step 213).

The excitation signal subframes are provided to the multiplier component 152. The multiplier component 152 multiplies the amplitude of the non-zero pulses in the received subframes with the gain factor in the received or interpolated comfort noise parameters (step 214).

The resulting excitation signal subframes are then provided to the LP synthesis filter component 153.

The LP synthesis filter component 153 configures an LP synthesis filter with the LP synthesis filter coefficients in the received or interpolated comfort noise parameters. This filter is then applied to the four generated subframes of an excitation signal to obtain a time scaled comfort noise signal (step 215). The time scaled comfort noise signals—or frames—are equally provided to the playback component 136 for presentation to a user.

The presented embodiment of the invention ensures that a comfort noise signal has a basically constant ratio of non-zero pulses per time unit, regardless of any applied time scaling. Consequently, also the energy of the signal per time unit, that is, the signal power, remains constant. Any change in the length of the comfort noise signal is thereby hidden from the user. Moreover, the gain factors that are received in the SID frames or that are interpolated can be used without any modification, since the suitably selected number of pulses guarantees that the signal level remains at the desired level without any additional computation.

It has to be noted that although the presented embodiment of the invention has been described specifically for AMR, the same mechanism can be applied to any codec using similar mechanism for comfort noise generation, another example being for instance AMR-WB.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures.

What is claimed is:

1. A method comprising:
synthesizing a comfort noise signal, and
performing a time scaling as an integral part of said comfort noise signal synthesis.

2. The method according to claim 1, further comprising:
buffering audio data, which is received via a packet switched network, in an adaptive jitter buffer;
determining a ratio between a required length of said comfort noise signal, which required length depends on reception statistics on said audio data, to a default length of a comfort noise signal; and
performing said time scaling in accordance with said determined ratio.

3. The method according to claim 1, wherein said time scaling comprises adjusting an energy per time unit of said comfort noise signal to approach an energy per time unit that would result without time scaling.

4. The method according to claim 1, wherein said synthesizing of a comfort noise signal comprises generating a time scaled excitation signal and applying a linear prediction synthesis filtering to said time scaled excitation signal.

5. The method according to claim 4, wherein generating said time scaled excitation signal comprises creating an excitation signal having a length which corresponds to a desired length of said comfort noise signal and including a number of non-zero pulses which is adjusted to said desired length.

6. The method according to claim 4, wherein generating said time scaled excitation signal comprises creating a number of subframes for said excitation signal, a length of said subframes being determined by adjusting a default length of a subframe in accordance with a ratio between a desired length of said comfort noise signal and a default length of a comfort noise signal.

7. The method according to claim 6, wherein said length of said subframes is selected in addition to lie between a predetermined maximum value and a predetermined minimum value.

8. The method according to claim 6, wherein generating said time scaled excitation signal further comprises including a selected number of non-zero pulses at random positions in each of said subframes, said selected number of non-zero pulses being determined by adjusting a default number of pulses per subframe according to said ratio.

9. The method according to claim 1, wherein said comfort noise signal is synthesized in the scope of one of an adaptive multirate coding and an adaptive multirate wideband coding.

10. An apparatus comprising a comfort noise generator configured to synthesize a comfort noise signal and to perform a time scaling as an integral part of said comfort noise signal synthesis.

11. The apparatus according to claim 10, wherein said comfort noise generator comprises an excitation signal generator configured to generate a time scaled excitation signal and a linear prediction synthesis filter arranged to filter said time scaled excitation signal for synthesizing said comfort noise signal.

12. The apparatus according to claim 10, wherein said apparatus is a chipset with at least one chip.

13. An audio receiver comprising:
an apparatus according to claim 10; and
a time scaling control logic configured to determine a required amount of time scaling, which is to be applied by said apparatus.

14. The audio receiver according to claim 13, further comprising:
an adaptive jitter buffer arranged to buffer audio data, which is received via a packet switched network.

15. The audio receiver according to claim 13, further comprising one of an adaptive multirate decoder and an adaptive multirate wideband decoder including said comfort noise generator.

16. An electronic device comprising:
an apparatus according to claim 10; and
a playback component configured to playback a comfort noise signal synthesized by said apparatus.

17. A system comprising transmitter configured to provide comfort noise parameters for transmission via a packet switched network and a receiver configured to receive comfort noise parameters via said packet switched network, said receiver including a comfort noise generator configured to synthesize a comfort noise signal based on comfort noise parameters received by said receiver and to perform a time scaling as an integral part of said comfort noise signal synthesis.

18. A software program product in which a software code is stored in a computer readable medium, wherein said software code realizes the following when being executed by a processor:
synthesizing a comfort noise signal; and
performing a time scaling as an integral part of said comfort noise signal synthesis.

19. The software program product according to claim 18, wherein said synthesizing of a comfort noise signal comprises generating a time scaled excitation signal and applying a linear prediction synthesis filtering to said time scaled excitation signal.

20. The software program product according to claim 19, wherein generating said time scaled excitation signal comprises creating an excitation signal having a length which corresponds to a desired length of said comfort noise signal and including a number of non-zero pulses which is adjusted to said desired length.

21. The software program product according to claim 19, wherein generating said time scaled excitation signal comprises creating a number of subframes for said excitation signal, a length of said subframes being determined by adjusting a default length of a subframe in accordance with a ratio between a desired length of said comfort noise signal and a default length of a comfort noise signal.

22. Apparatus comprising:
means for synthesizing a comfort noise signal; and
means for performing a time scaling as an integral part of said comfort noise signal synthesis.

23. The apparatus of claim 22, further comprising:
means for buffering audio data, which is received via a packet switched network, in an adaptive jitter buffer;
means for determining a ratio between a required length of said comfort noise signal, which required length depends on reception statistics on said audio data, to a default length of a comfort noise signal; and
means for performing said time scaling in accordance with said determined ratio.
